(19) United States
(12) Patent Application Publication
(10) Pub. No.: US 2007/0293246 A1
(43) Pub. Date: Dec. 20, 2007

(54) Method and apparatus for improved control of intelligent network-based user features

(75) Inventors: Gerald W. Pfleging, Batavia, IL (US); George Paul Wilkin, Bolingbrook, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/471,333

(22) Filed: Jun. 20, 2006

(51) Int. Cl. H04Q 7/20

(52) U.S. Cl. 455/461; 455/418; 455/466; 709/223

(57) ABSTRACT

A method and apparatus for improved control of intelligent network-based user features is provided. In this regard, the invention relates to a system and method useful for managing a user profile of a virtual private network system, such as an eVPN system, through manipulation of a mobile device, e.g. a mobile phone. In one form, short message service (SMS) messages can be used to facilitate such control.

### BACKGROUND

This invention relates to a method and apparatus for improved control of intelligent network-based user features. In this regard, the invention relates to a system and method useful for managing a user profile of a virtual private network system, such as an eVPN system, through manipulation of a mobile device, e.g. a mobile phone. In one form, short message service (SMS) messages can be used to facilitate such control.

While the invention is particularly directed to the art of intelligent networks, and will be thus described with specific reference thereto, it will be appreciated that the invention may have usefulness in other fields and applications. For example, the invention may be used to simulate any configurable and/or virtual phone network.

By way of background, cellular phone proliferation and usage among corporate users continues to rise around the world. A majority of corporate users' phones are provided by their respective employers. Until recently, corporations could do little to monitor the activity on these phones such as the types of incoming and outgoing calls to phones, the timing of when calls could be accepted, or control of who a user can call.

With the advent of intelligent networks and virtual private networks, such as the Lucent Technologies enhanced Virtual Private Network (eVPN) system, more granular control of one or groups of mobile users is currently possible. The system, among other things, gives corporate administrators the ability to control such parameters as hours of use for the mobile device, numbers that can be called or received by subscribers, call treatment options for calls that are not answered or accepted by the system, and parameters for calling restrictions or non-network connection.

One of the shortcomings of the currently implemented system is that the control of these features requires a user to use a web-based system to enter changes to the features that may be subscribed for any particular user. To further complicate matters, the web-based system is now typically only targeted for corporate administrators. Efforts are underway to ease this restriction, but even when that is complete, users will still need web access to have changes to their features completed.

Most handset manufactures are currently allowing users to control the ringing on their devices by choosing profiles that can make the phone silent, vibrate or other indicators of an incoming call that may alert the handset user to the call. Typically, this results in the call going to voicemail based on the network timeout for the call not being answered.

It is desirable to allow a subscriber to use convenient on-device controls to change the behavior of the subscriber's incoming call functionality. This desire is particularly acute in the environment of a virtual private network. However, such functionality does not exist.

The present invention contemplates a new and improved system and method that resolves the above-referenced difficulties and others.

### SUMMARY

A method and apparatus for improved control of intelligent network-based user features are provided.

In one aspect of the invention, the system comprises a web-based interface operative to manipulate a first set of parameters within the user profiles maintained in the intelligent network, a mobile device interface operative to manipulate a second set of parameters within a selected user profile maintained in the intelligent network, a service manager module operative to receive information based on the manipulation of the first set of parameters and the second set of parameters and to render changes to the user profiles based thereon and an application server operative to manage calls in the intelligent network based on the user profiles.

In another aspect of the invention, the mobile device interface is operative to generate and transmit short message service (SMS) messages.

In another aspect of the invention, the service manager module is operative to receive and interpret short message service (SMS) messages.

In another aspect of the invention, the mobile device interface is a mobile web-based interface.

In another aspect of the invention, the mobile device interface is based on touchtone communication.

In another aspect of the invention, the system comprises a service manager module operative to receive information based on manipulation of a first set of parameters within the user profiles and a second set of parameters within the user profiles and to render changes to the user profiles based thereon and an application server operative to manage calls in the intelligent network based on the user profiles.

In another aspect of the invention, the first set of parameters is manipulated through a web-based interface.

In another aspect of the invention, the second set of parameters is manipulated through a mobile device interface.

In another aspect of the invention, the mobile device interface is operative to generate and transmit short message service (SMS) messages.

In another aspect of the invention, the service manager module is operative to receive and interpret the short message service (SMS) messages.

In another aspect of the invention, the mobile device interface is a mobile web-based interface.

In another aspect of the invention, the mobile device interface is based on touchtone communication.

In another aspect of the invention, the method comprises selectively manipulating a first set of parameters within a user profile through a web-based interface, generating first signals based on the manipulating of the first parameters, transmitting the generated first signals, selectively manipulating a second set of parameters within a user profile through a mobile device interface, generating second signals based on the manipulating of the second set of parameters, transmitting the generated second signals, receiving at least one of the transmitted first signals and the transmitted second signals and modifying the user profiles based on the at least one received first signals and second signals.

In another aspect of the invention, the second signals are short message service (SMS) signals.

In another aspect of the invention, the second signals are mobile web-based.

In another aspect of the invention, the second signals are touchtone service signals.

In another aspect of the invention, the method further comprises managing calls in the intelligent network based on the user profiles.

In another aspect of the invention, the method comprises selectively receiving first information from a web-based application interface based on manipulation of a first set of parameters within the user profiles, selectively receiving second information from a mobile device based on manipulation of a second set of parameters within the user profiles, selectively modifying the user profiles based on at least one of the received first and second information and managing calls in the intelligent network based on the user profiles.

In another aspect of the invention, the second information is a short message service (SMS) message.

In another aspect of the invention, the second information is touchtone-based information.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a representative view of a network into which the presently described embodiments may be implemented.

FIG. 2 is a flow chart illustrating a method according to the presently described embodiments.

FIG. 3 is a flow chart illustrating a method according to the presently described embodiments.

### DETAILED DESCRIPTION

The presently described embodiments are directed to an improved system to control, for example, a wireless intelligent network. The improvement resides in the recognition that, while enterprises should have control over a variety of parameters that govern usage of an intelligent network, the users should also have control over at least some of such parameters. In this regard, the presently described embodiments provide a user interface in addition to the conventional, web-based administrative interface that currently exists. The user interface, in one form, provides the ability for the user to send messages (e.g. SMS messages) to the intelligent network to modify selected user profile parameters. In this way, the enterprise has the ability to set parameters and constraints (e.g. a first set of parameters) for users through the administrative web-based interface while the user may modify selected parameters (e.g. a second set of parameters) within the constraints set by the enterprise. Thus, in some cases, a hierarchy of profile control and management may be realized.

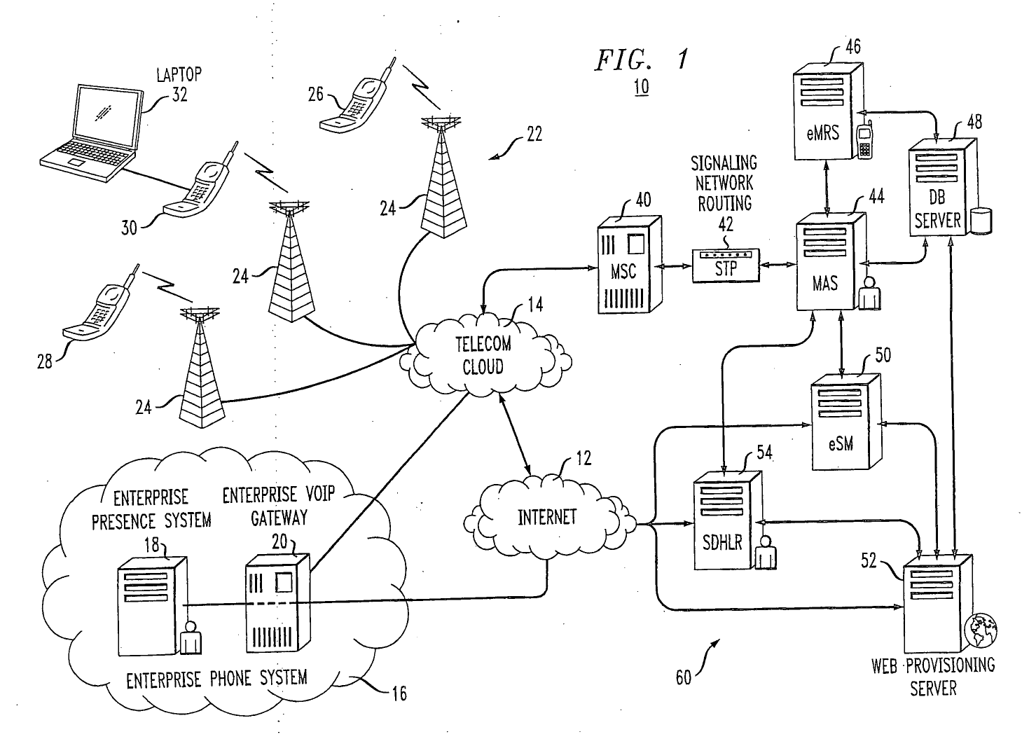

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally, FIG. 1 illustrates a network 10.

The network 10 includes a variety of network elements that are in communication with, for example, the Internet 12 and/or the telecommunications network 14. In particular, an enterprise phone system 16 having an enterprise presence system 18 and an enterprise Voice-over-Internet-Protocol (VoIP) gateway 20 communicate with the Internet 12 and the telecommunications network 14. It should be appreciated that the configuration of the Enterprise Phone System 16 may take a variety of forms, such as a PBX system or a Centrex system, so the invention described herein should not be limited to implementation with any one configuration. The system 16 is also operative for provisioning for an intelligent network or a virtual private network, such as the enhanced Virtual Private Network (eVPN) noted above. Again, this provisioning is accomplished using a web interface that is typically available only to the administration of the Enterprise Phone System 16. The web interface is operative to manipulate a first set of parameters relating to user profiles that are typically maintained in the network.

Network 10 also includes a wireless network 22. The network 22 is a virtual extension of the Enterprise Phone System 16. So, users of the system 16 may gain the advantages of the system, even if they are physically located in different places than the system 16. The network 22 may take a variety of configurations, but, as shown, base stations 24 communicate with mobile devices, such as mobile devices 26, 28 and 30, which are illustrated as mobile phones. The mobile devices include an interface operative to manipulate a second set of parameters within a selected user profile maintained in the intelligent network. In one form, the mobile device interface is operative to generate and transmit short message service (SMS) messages. In another form, the interface is operative to allow for touchtone communication and the generation of touchtone (TT) service signals. Menu prompting may be implemented in this case. Of course, the mobile device interface may also be web-based. It will be understood that the interface may take on a variety of appearances and configurations suited to the technology used. In the illustrated form, the mobile device 30 is also in communication with a laptop computer 32. It should be understood that the laptop computer 32 may include an interface that is useful in providing interface functionality to the mobile device, as described below.

Also shown in the network 10 are a mobile switching center (MSC) 40, a signal transfer point 42, and an intelligent network application server 44. In one form, the intelligent network application server 44 is a MyLife Application Server (MAS) provided by Lucent Technologies. In any form, however, the server 44 acts as a virtual switch for the intelligent network and holds the core platform therefor.

The intelligent network application server 44 communicates with an intelligent network media server 46, a database server 48, and a service manager 50. The application server 44 may take a variety of forms, but it is, in one form, operative to manage calls in the intelligent network based on the user profiles.

In one form, the intelligent network media server 46 is an enhanced Media Resource Server (eMRS) provided by Lucent Technologies. In an example form, however, the server 46 is operative to manage, for example, voice response functionality, voice prompting/messaging, announcements, touchtone functionality, voicemail functionality and the like.

Likewise, in one form, the service manager (or service manager module) 50 may be an enhanced Service Manager (eSM) provided by Lucent Technologies. In an example form, however, the service manager 50 provides an administrative interface for the system. In this way, a service manager module is operative to receive information based on the manipulation of the first set of parameters and the second set of parameters and to render changes to the user profiles based thereon. Messages (or signals or information) from mobile devices contemplated herein are received at the service manager. In this regard, in one form, the service manager module is operative to receive and interpret short message service (SMS) messages. As noted, the service manager may also be operative to receive and interpret touchtone (TT) service signals. Also, a web interface, such as the web interface for an administrator noted above, is provided. In addition, service manager 50 maintains all user profiles for the intelligent network and transmits copies thereof to other network elements, such as the application server 44, as necessary. Typically, most if not all human interfaces for the intelligent network are achieved through the service manager 50.

The service manager 50 is in communication with a web provisioning server 52, which may also be incorporated within the service manager 50. It should be understood that the provisioning server 52 is operative to handle web-based interactions to manipulate profiles stored in the server 50, such as those contemplated above through use by an administrator of the web interface of laptop 32, as well as mobile device interactions. The mobile device interactions, in one form, are short message service (SMS) messages. With this configuration, the provisioning server is configured to recognize the digit strings of SMS messaging to allow a user to manipulate its profile. In another form, the mobile device interactions are touchtone-based and menu driven. In this case, the server is configured to interpret the touchtone information (touchtone (TT) service signals) to allow a user to manipulate its profile. In another form, the mobile device interactions may also be web-based.

Also shown in the network is a home location register (HLR), such as a super distributed home location register (SDHLR). It should be appreciated that application server 44, the media server 46, the database server 48, the service manager 50 and the web provision server 52 comprise an intelligent network 60.

In operation, a user with a subscribed mobile device (e.g. mobile devices 26, 28, or 30) would be able to choose predetermined or custom profiles from the handset. The profiles could be pre-stored on the device from the manufacturer, sent through the network (e.g. from the service manager 50) to the handset, or created on the device itself by using a web-based or stand-alone application (such as through the computer 32, for example). The applications can have Internet-based connections to the network to provide the provisioning or allow messages from applications (stand-alone or web) to be uploaded to the phone and then provided to the provisioning systems using any of the available networks to the phone.

Incoming calls to the users' device (e.g. mobile devices 26, 28, or 30) are routed to the intelligent network 60 based on instructions provided by the Enterprise Phone System 16 on if/how these users' incoming calls are to be handled. Most likely, since an enterprise has subscribed a users' device to the service, they are expecting that they will have some control over how and when the user can use their device. The presently described embodiments allow the user to have more granular control over how the incoming calls will be handled (within the parameters defined by the enterprise that owns the device (& service)).

For example, when a user decides that for some period of time that they do not want to receive calls on their device, they can use the currently supplied profile change functionality of the handset to select the mode that they would like to be in (for example, meeting). Once the user chooses the profile they would like to use, the phone then initiates a communication with the network to update the intelligent network 60 with the appropriate status setting for this device. Currently, when choosing a setting such as “meeting,” the phone simply won't ring. Under the presently described embodiments, the mobile device will send messages to the back-end of the intelligent network and allow custom call treatment for any incoming calls, while the setting is set. The profile choice could be timed on the device itself (after expiration of which the system device would automatically send another set of commands to the network to place the phone in the normal state).

Once the intelligent network 60 has the information on the current phone state, it can provide whatever requested call treatment for incoming calls. These could include simply sending the call to voicemail, checking what time of day it is and determine an action, determining date, day of month or year and determining an action, rejecting the call, playing custom messages and then redirecting to another treatment or allowing the call to go through and override the devices current settings.

The level of detail of the call treatments could be controlled by the service provider, the enterprise, or the local entity within the enterprise to determine the kinds of changes and duration of use. If the controlling entity deemed that “meeting” state can only last for 3 hours, then after the time is expired, the intelligent network would initiate a message sequence to get the phone to enter normal state again, and notify the user that this has occurred (e.g. SMS message, phone beep, phone application message or sound).

In addition to the profile changes (away, meeting, home, etc.), the system is able to handle custom calling lists or groups, and allow different call handling for the members of the groups. The setup of these groups and all the profiles can be provisioned on the device itself or be provisioned using the above-mentioned stand-alone or web provisioning methods.

The profile features of the phone that initiate the messages with the network are provisioned when the phone is brought into service as an intelligent network subscriber. Again, the actual changes to the current phone functionality could be programmed at the factory before the phone is shipped or be provided using the current phone update mechanisms in place in the industry to update the device functionality currently.

In addition to the provided profile change capability, a mobile programming language could be used to provide this functionality to devices lacking the necessary profile programming. This application could be written in one of many languages including (WAP, Java or J2ME, Python, Symbian, WML, etc.). Any application that is needed for this functionality could be provisioned on the device using currently available methods.

The system also has the ability to update systems, such as an SDHLR to mark the user as “not available” or send messages to network-based or corporate-based presence systems to note the users unavailability to handle calls.

It should be understood that the methods according to the presently described embodiments can be implemented by any suitable combination of hardware configurations and software routines. For example, the methods may be implemented by maintaining and/or executing software routines on specific network elements. In one form, software routines are maintained and executed on the service manager. In another form, software routines are maintained and executed in a distributed manner. For example, software routines that implement the presently described embodiments may reside on the service manager, the application server, and/or the mobile devices.

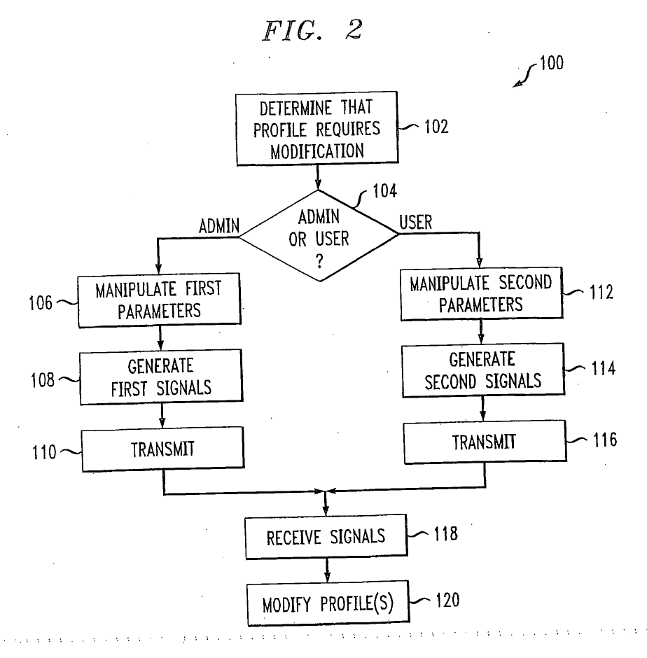

While the combination of hardware and software may be realized in different manners, at least one form of the invention takes the form of a method as shown in the flowchart of FIG. 2. Referring now to FIG. 2, a method 100 is represented. As shown, the method is initiated by a decision that a user profile (or profiles) requires modification (at 102). The process to make the changes depends on whether the individual is an administrator or a user (at 104).

If the individual is an administrator, the administrator selectively manipulates the first set of parameters within a user profile through a web-based interface (at 106). The web interface then generates first signals based on the manipulating of the first parameters (at 108). These signals are transmitted (at 110).

If the individual is simply an ordinary user, the user selectively manipulates the second set of parameters within a user profile through a mobile device interface (at 112). As noted above, in one form, the mobile device interface is operative to generate SMS type messages. Second signals based on the manipulating of the second set of parameters are then generated (at 114). These second signals are then transmitted (at 116). It should be appreciated the method of communication for the device (e.g. mobile device 26, 28 or 30) to the intelligent network can be accomplished using established communication protocols and methods over the current wireless network implementations. So, the second signals may take the form of SMS messages, as above, or touchtone (TT) service signals or mobile web-based signals.

The intelligent network (e.g. the provisioning server 52 or the service manager 52) receives at least one of the transmitted first signals and the transmitted second signals (at 118). These signals are used to modify the user profiles based on the at least one received first signals and second signals (at 120). Of course, the intelligent network will then manage calls based on the user profiles.

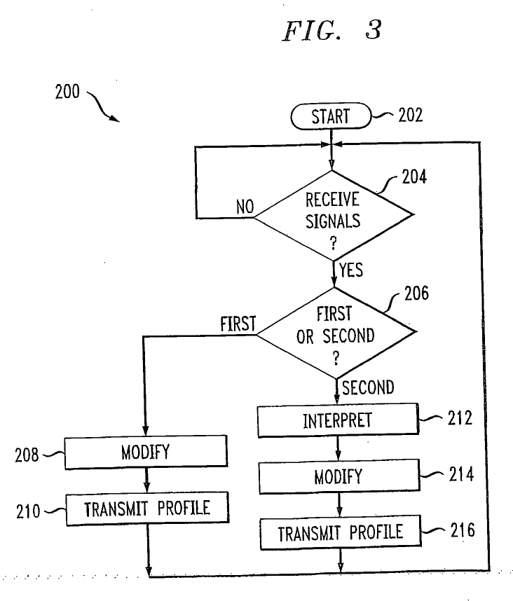

FIG. 2 represents a method that initiates the functionality for a variety different network elements. Referring now to FIG. 3, a method 200 is set forth that represents a perspective of a particular appropriate network element, e.g. the service manager 50.

As shown, the method commences (at 202) and waits for the service manager to receive signals or information (at 204). If no signals are received, then the process continues to wait. Once signals are received, a determination is made as to whether the signals are first or second signals or information (at 206). As can be appreciated, the service module determines whether first information (or signals) from a web-based application interface (based on manipulation of a first set of parameters within the user profiles) or second information from a mobile device (based on manipulation of a second set of parameters within the user profiles) is received.

If first signals are received, the profiles are modified in manners that are known to those of skill in the field (at 208). The profile is then transmitted to, for example, the application server so that the intelligent network can manage calls based on the modified profiles (at 210).

If second signals are received, then an interpretation of those signals may be necessary (at 212). In this regard, if the second signals are SMS messages, the provisioning server or the service manager will initiate a routine to interpret the digit string of the SMS message(s). Once the interpretation is complete, the profiles are modified in an appropriate manner (at 214) and transmitted as above (at 216). After completion of processing, the method returns to a wait state.

A practical advantage of the present invention is that the contemplated fee structure for this service is flexible. It may be included in the packaging prices for the “enterprise” service for the devices. However, advanced pricing models could also be employed and billing records generated on a desired platform.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system for use in an intelligent network having associated therewith user profiles, the system comprising:
a web-based interface operative to manipulate a first set of parameters within the user profiles maintained in the intelligent network;
a mobile device interface operative to manipulate a second set of parameters within a selected user profile maintained in the intelligent network;
a service manager module operative to receive information based on the manipulation of the first set of parameters and the second set of parameters and to render changes to the user profiles based thereon; and,
an application server operative to manage calls in the intelligent network based on the user profiles.

2. The system as set forth in claim 1 wherein the mobile device interface is operative to generate and transmit short message service (SMS) messages.

3. The system as set forth in claim 2 wherein the service manager module is operative to receive and interpret short message service (SMS) messages.

4. The system as set forth in claim 1 wherein the mobile device interface is a mobile web-based interface.

5. The system as set forth in claim 1 wherein the mobile device interface is based on touchtone communication.

6. A system for use in an intelligent network having associated therewith user profiles, the system comprising:
a service manager module operative to receive information based on manipulation of a first set of parameters within the user profiles and a second set of parameters within the user profiles and to render changes to the user profiles based thereon; and,
an application server operative to manage calls in the intelligent network based on the user profiles.

7. The system as set forth in claim 6 wherein the first set of parameters is manipulated through a web-based interface.

8. The system as set forth in claim 6 wherein the second set of parameters is manipulated through a mobile device interface.

9. The system as set forth in claim 8 wherein the mobile device interface is operative to generate and transmit short message service (SMS) messages.

10. The system as set forth in claim 9 wherein the service manager module is operative to receive and interpret the short message service (SMS) messages.

11. The system as set forth in claim 8 wherein the mobile device interface is a mobile web-based interface.

12. The system as set forth in claim 6 wherein the mobile device interface is based on touchtone communication.

13. A method for use in an intelligent network, the intelligent network having associated therewith user profiles, the method comprising:
selectively manipulating a first set of parameters within a user profile through a web-based interface;
generating first signals based on the manipulating of the first parameters;
transmitting the generated first signals;
selectively manipulating a second set of parameters within a user profile through a mobile device interface;
generating second signals based on the manipulating of the second set of parameters;
transmitting the generated second signals;
receiving at least one of the transmitted first signals and the transmitted second signals; and,
modifying the user profiles based on the at least one received first signals and second signals.

14. The method as set forth in claim 13 wherein the second signals are short message service (SMS) signals.

15. The method as set forth in claim 13 wherein the second signals are mobile web-based.

16. The method as set forth in claim 13 wherein the second signals are touchtone service signals.

17. The method as set forth in claim 13 further comprising managing calls in the intelligent network based on the user profiles.

18. A method for use in an intelligent network, the intelligent network having associated therewith user profiles, the method comprising:
selectively receiving first information from a web-based application interface based on manipulation of a first set of parameters within the user profiles;
selectively receiving second information from a mobile device based on manipulation of a second set of parameters within the user profiles;
selectively modifying the user profiles based on at least one of the received first and second information; and,
managing calls in the intelligent network based on the user profiles.

19. The method as set forth in claim 18 wherein the second information is a short message service (SMS) message.

20. The method as set forth in claim 18 wherein the second information is touchtone-based information.
